(19) United States
(12) Patent Application Publication
(10) Pub. No.: US 2026/0103931 A1
(43) Pub. Date: Apr. 16, 2026

(54) ANTI-OBSTRUCTION SYSTEM HAVING A RELEASE STOP WITH A RELEASE ASSEMBLY

(71) Applicant: ASSA ABLOY Accessories and Door Controls Group, Inc., Monroe, NC (US)

(72) Inventor: Audomsoewanyque Houy, Memphis, TN (US)

(73) Assignee: ASSA ABLOY Accessories and Door Controls Group, Inc., Monroe, NC (US)

(21) Appl. No.: 19/352,647

(22) Filed: Oct. 8, 2025

Related U.S. Application Data
(60) Provisional application No. 63/706,961, filed on Oct. 14, 2024.

(51) Int. Cl. E05F 5/06

(52) U.S. Cl. CPC E05F 5/06; E05Y 2201/214; E05Y 2201/22; E05Y 2201/224

(57) ABSTRACT

An anti-obstruction system for improved safety in the event a barrier becomes obstructed by objects or a person. The anti-obstruction system utilizes a double swing hinge and an emergency release stop to act as the stop for the barrier so that the barrier can only swing in one direction. The release stop may have a support member (e.g., coupled to a frame) and a stop member coupled together through the use of a cover. The stop member stops the door from swinging in two directions when the release stop is engaged and allows the door to swing past the stop member when it is disengaged. The release stop may be engaged and disengaged through the use of a release lock that has one or more projections that restrict movement between the support member, the stop member, and/or the cover when engaged, and allows for movement when disengaged.

### CROSS REFERENCE AND PRIORITY CLAIM UNDER 35 U.S.C. §119

This application claims priority to U.S. Provisional Application No. 63/706,961 titled “Anti-Obstruction System Having a Release Stop with a Release Assembly” filed on October 14^{th}, 2024, which is assigned to the assignee hereof and the entirety of which is incorporated by reference herein.

### FIELD

The present disclosure generally relates to anti-obstruction systems, and in particular, a release assembly for the emergency release stop of the anti-obstruction system.

### BACKGROUND

Anti-obstruction door systems are utilized in order to allow an in-swinging door to swing outwardly (e.g., from a room, or the like) when the in-swinging door is obstructed (e.g., barricaded, blocked by a person, or the like). Anti-obstruction door systems may be utilized in facilities, including medical facilities, which may require the use of anti-obstruction door systems in order to allow people (e.g., professionals, or the like) to access locations of a structure when an in-swinging door is obstructed. Anti-obstruction door system products, including hinges and release stops of anti-obstruction door systems, may be improved.

### SUMMARY

Embodiments of the disclosure relate to anti-obstruction systems utilized to improve safety and mitigate risk in the event a barrier (e.g., door, or the like) providing egress into a structure (e.g., building, room, or the like) becomes obstructed by objects or a person. In particular embodiments, the anti-obstruction system may be utilized in medical, behavioral health, and/or assisted living environments, such as in rooms (e.g., patient, resident, or the like rooms), bathrooms, cross corridor bathrooms, or other areas. The anti-obstruction systems of the present disclosure provide an improved efficient solution to access someone in the event a barrier is obstructed and not able to open (e.g., not able to open inwardly). That is, in an emergency, the barrier is able to swing in the opposite direction from the normal operation in order to minimize potential risks to people located on the opposite side of an obstructed barrier.

As will be discussed in further detail herein, the anti-obstruction systems utilize one or more hinges (e.g., a double swing hinge, or the like), a release stop (otherwise described herein as an emergency release stop (ERS), release stop apparatus, or the like), and/or handle and lock hardware. The one or more hinges may be operatively coupled to a frame and/or a wall, and an edge of a barrier (e.g., a door, or the like), while the release stop is operatively coupled to an opposing frame and/or an opposing wall. The release stop, as will be described in further detail herein, acts as the stop for the barrier so that the barrier can only swing in one direction (e.g., into a room). However, when the barrier is required to swing in an opposite direction (e.g., outwardly from a room) the release stop may be disengaged to allow the barrier to swing in another direction (e.g., outwardly from a room).

Instead of using a traditional stop located in the barrier frame, the anti-obstruction system (otherwise described as an anti-obstruction door system) of the present invention utilizes a release stop, which when engaged only allows the barrier to swing in one direction (e.g., inwardly or outwardly). Alternatively, when the release stop is disengaged the barrier may swing in two directions (e.g., inwardly and outwardly). The release stop comprises a first release portion (otherwise described as a support member, a frame support member, or the like) and a second release portion (otherwise described as a stop member, release stop member, swing stop member, or the like), a cover, and a release assembly. The release assembly may comprise a release lock (e.g., a sliding release lock, or the like), a rod operatively coupled to the sliding release lock, and a release connector. The release connector is configured to restrict or allow movement of the sliding release lock to allow for engagement or disengagement of the rod, and thus, the stop member of the release stop. When in the engaged position the release stop acts as a frame stop that prevents a barrier from swinging past the release stop. However, when there is a need for the barrier to swing past the release stop, such as when an inwardly swinging door is obstructed, the release connector may be unlocked such that the a release lock (e.g., a sliding release lock, or the like) of the release assembly may also be unlocked in order to move the rod, and thus the stop member, from an engaged position to a disengaged position in order allow the release stop member to move such that the barrier is able to swing in both directions (e.g., outwardly and inwardly).

When the sliding release lock and the release connector are in the locked position, the rod (e.g., within the stop member) is in the engaged position such that it is extended into a rod stop (not illustrated), which restricts (e.g., prevents, aids in preventing, or the like) the stop member from moving. When the release connector and the sliding release lock are in the unlocked position, the rod is disengaged such that it is retracted from the rod stop, which allows for the stop member to swing open to allow the barrier to swing in both directions. It should be understood that the rod stop may be formed by the frame and/or wall, such as an aperture (e.g., opening, such as a hole) in the frame and/or wall. Alternatively, or additionally, the rod stop may be a separate component (e.g., cylinder, other shaped stop, or the like) that is operatively coupled to the frame and/or wall (e.g., to the outside, inside, or the like thereof).

On embodiment comprises a release stop for a barrier. The release stop comprises a support member configured to be operatively coupled with a frame or a wall, a stop member operatively coupled with the support member, a cover operatively coupled to the support member and the stop member, and a release assembly operatively coupled to the stop member. The release assembly comprises a sliding release lock, a rod operatively coupled to the sliding release lock, and a release connector. The release connector is configured to restrict or allow movement of the sliding release lock to allow for engagement or disengagement of the rod. In an engaged position the rod is engaged to restrict movement of the stop member. In a disengaged position the rod is disengaged to allow movement of the stop member.

In further accord with embodiments, the release assembly further comprises a release housing at least partially covering the sliding release lock. The release housing forms a finger aperture configured to allow a user to slide the sliding release lock.

In other embodiments, the rod comprises a proximate end operatively coupled to the sliding release lock and a distal end that is configured to engage and disengage with a rod stop.

In still other embodiments, in the disengaged position the rod is located within the release stop, and in the engaged position the distal end extends from the release stop.

In yet other embodiments, the sliding release lock comprises a rod projection that is operatively coupled to the rod.

In other embodiments, the rod stop is formed by the frame having a frame aperture, the wall having a wall aperture, or rod stop housing operatively coupled to the frame or the wall.

In further accord with embodiments, the sliding release lock comprises a connector projection. The release connector is configured to restrict and allow movement of the sliding release lock through locking and unlocking with the connector projection.

In other embodiments, when the sliding release lock and the release connector are in a locked position the rod is in the engaged position.

In still other embodiments, when the release connector and the sliding release lock are in an unlocked position the rod is in the disengaged position.

In yet other embodiments, when the release connector is unlocked the sliding release lock slides downward to the unlocked position automatically to move the rod to the disengaged position.

In other embodiments, the stop member comprises a stop web, and a stop head with stop teeth. The stop head extends from the stop web.

In further accord with embodiments, the support member comprises a support web, and a support head with support teeth. The support head extends from the support web.

In other embodiments, the cover extends over at least a portion of the support head and the stop head.

In still other embodiments, the cover comprises a cover web, one or more cover flanges, and one or more returns extending from the one or more cover flanges. The stop head or the support head receives the one or more returns.

In yet other embodiments, the release stop further comprises a cover cap operatively coupled with the cover, and a stop member cap operatively coupled with the stop member.

Another embodiment comprises an anti-obstruction system. The system comprises a door frame operatively coupled to a wall, a door having a first door edge and a second door edge, one or more hinges operatively coupled to a first frame portion of the door frame and the door adjacent the first door edge, and a release stop. The release stop comprises a support member operatively coupled to a second frame portion of the door frame, a stop member configured to engage and disengage with the door adjacent the second door edge, a cover operatively coupled to the support member and the stop member, and a release assembly operatively coupled to the stop member. The release assembly comprises a sliding release lock, a rod operatively coupled to the sliding release lock, and a release connector. The release connector is configured to restrict or allow movement of the sliding release lock to allow for engagement or disengagement of the rod. In an engaged position the rod is engaged to restrict movement of the stop member. In a disengaged position the rod is disengaged to allow movement of the stop member.

In further accord with embodiments, when the sliding release lock and the release connector are in a locked position the rod is in the engaged position.

In other embodiments, when the release connector and the sliding release lock are in an unlocked position the rod is in the disengaged position.

In still other embodiments, when the release connector is unlocked the sliding release lock slides downward to the unlocked position automatically to move the rod to the disengaged position.

Another embodiment of the invention comprises a method of using an anti-obstruction system for allowing a barrier that swings inwardly to swing outwardly. The anti-obstruction system comprises a door frame operatively coupled to a wall, a door having a first door edge and a second door edge, one or more hinges operatively coupling a first frame portion of the door frame and the door adjacent the first door edge, and a release stop. The release stop comprises a support member operatively coupled to a second frame portion of the door frame, a stop member configured to engage and disengage with the door adjacent the second door edge, a cover operatively coupled to the support member and the stop member, and a release assembly operatively coupled to the stop member. The release assembly comprises a sliding release lock, a rod operatively coupled to the sliding release lock, and a release connector. The method comprises unlocking the release connector to allow movement of the sliding release lock, moving the sliding release lock to move the rod from an engaged position to a disengaged position to allow for movement of the stop member, and moving the stop member to allow the door to swing outwardly past the stop member.

To the accomplishment of the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings.

FIG. 1 is an outside view of an anti-obstruction door system with a double swing hinge and a release stop, in accordance with embodiments of the present disclosure.

FIG. 2 is an inside view of the anti-obstruction door system when obstructed, in accordance with embodiments of the present disclosure.

FIG. 3A is a cross-sectional top view of an anti-obstruction door system for a left-hand inward opening door, in accordance with embodiments of the present disclosure.

FIG. 3B is a cross-sectional top view of an anti-obstruction door system for a right-hand inward opening door, in accordance with embodiments of the present disclosure.

FIG. 4 is a perspective view of a double swing hinge for an anti-obstruction door system, in accordance with embodiments of the present disclosure.

FIG. 5A is a cross-sectional top view of a double swing hinge for an anti-obstruction door system, in accordance with embodiments of the present disclosure.

FIG. 5B is a cross-sectional top view of the range of movement of the double swing hinge, in accordance with embodiments of the present disclosure.

FIG. 6 is a perspective view of a portion of a release stop for an anti-obstruction door system, in accordance with embodiments of the present disclosure.

FIG. 7A is a cross-sectional top view of a release stop for an anti-obstruction door system, in accordance with embodiments of the present disclosure.

FIG. 7B is a cross-sectional top view of the range of movement of the release stop for an anti-obstruction door system, in accordance with embodiments of the present disclosure.

FIG. 8A is a perspective view of a release stop for an anti-obstruction door system, in accordance with embodiments of the present disclosure.

FIG. 8B is an enlarged perspective view of a portion of the release stop of FIG. 8A for an anti-obstruction door system, in accordance with embodiments of the present disclosure.

FIG. 9A is a view of the upper portion of the release stop for an anti-obstruction door system of FIG. 8A when disengaged, in accordance with embodiments of the present disclosure.

FIG. 9B illustrates an enlarged view of the upper portion of the release stop of FIG. 9A with the cover removed, in accordance with embodiments of the present disclosure.

FIG. 9C illustrates an enlarged view of the upper portion of the release stop of FIG. 9A with the cover and cover cap removed, in accordance with embodiments of the present disclosure.

FIG. 9D illustrates a top view of the upper portion of the release stop of FIG. 9A, in accordance with embodiments of the present disclosure.

FIG. 9E illustrates a top view of the upper portion of the release stop of FIG. 9A with the cover cap and the release stop cap removed, in accordance with embodiments of the present disclosure.

FIG. 10A illustrates an enlarged perspective view of the release lock of FIG. 8A in the form of a sliding release lock in the locked position, in accordance with embodiments of the present disclosure.

FIG. 10B illustrates a font view of the sliding release lock of FIG. 10A in the locked position, in accordance with embodiments of the present disclosure.

FIG. 10C illustrates a font view of the sliding release lock of FIG. 10A in the unlocked position, in accordance with embodiments of the present disclosure.

FIG. 11A illustrates a perspective view of the release stop of FIG. 8A with the stop member removed, in accordance with embodiments of the present disclosure.

FIG. 11B illustrates an enlarged front perspective view of the sliding release lock of the release stop of FIG. 11A with the stop member and sliding release lock housing removed, in accordance with embodiments of the present disclosure.

FIG. 11C illustrates an enlarged rear perspective view of the sliding release lock of the release stop of FIG. 11A with the stop member and the sliding release lock removed, in accordance with embodiments of the present disclosure.

FIG. 11D illustrates an enlarged side perspective view of the sliding release lock of the release stop of FIG. 11A with the stop member and sliding release lock housing removed, in accordance with embodiments of the present disclosure.

FIG. 12A illustrates an enlarged cross-sectional side view of the release stop with the lock connector locked, in accordance with embodiments of the present disclosure.

FIG. 12B illustrates an enlarged cross-sectional side view the release stop with the lock connector unlocked, in accordance with embodiments of the present disclosure.

FIG. 13A illustrates a perspective view of the release stop of FIG. 8A with the stop member and the lock housing removed, and the rod in the engaged position, in accordance with embodiments of the present disclosure.

FIG. 13B illustrates a perspective view of the release stop of FIG. 8A with the stop member and the lock housing removed, and the rod in the disengaged position, in accordance with embodiments of the present disclosure.

FIG. 14 illustrates a perspective view of the grip of the release stop of FIG. 8A, in accordance with embodiments of the present disclosure.

FIG. 15 is a method of manufacturing, installing, and operating the anti-obstruction door system, in accordance with embodiments of the present disclosure.

### DETAILED DESCRIPTION

The following detailed description teaches specific example embodiments of the invention; however, other embodiments of the invention do not depart from the scope of the present invention. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including” when used herein, specify the presence of stated features, steps, operations, elements, and/or components, but do not preclude the presence or addition of one or more other features, steps, operations, elements, components, and/or groups thereof.

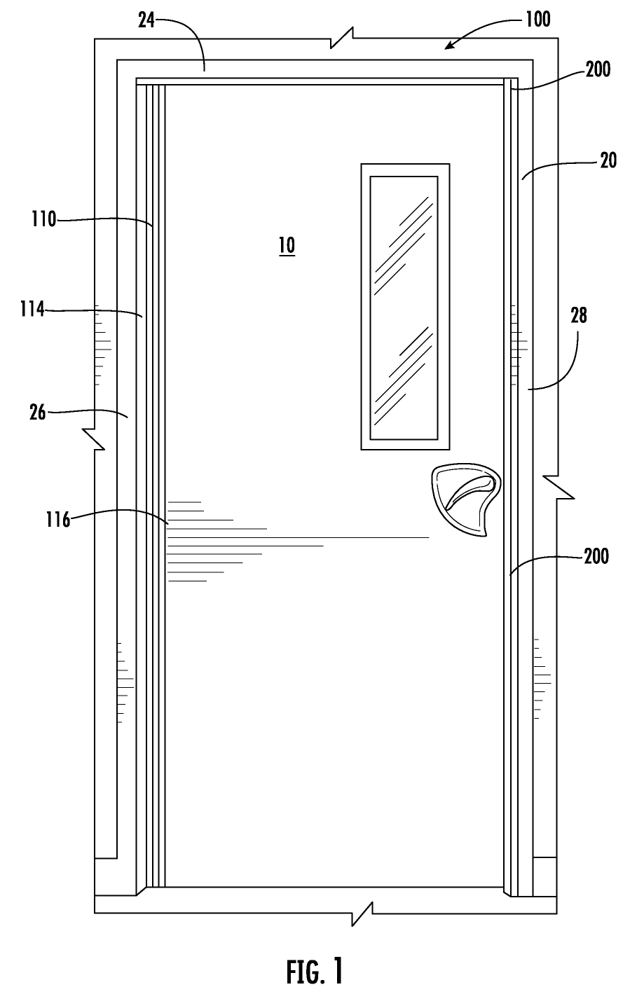

Referring now to the drawings, wherein like reference numerals designate corresponding or similar elements throughout the several views, embodiments of an anti-obstruction system 100 are illustrated in FIGS. 1 through 14. An anti-obstruction system 100 is utilized to improve safety and mitigate risk in the event a barrier 10 (e.g., door, or the like) providing egress into a structure (e.g., building, room, or the like) becomes obstructed by objects (e.g., a person, furniture, door stops, or the like). In particular embodiments, the anti-obstruction system 100 may be utilized in medical, behavioral health, and/or assisted living environments, such as in rooms (e.g., patient, resident, or the like rooms), bathrooms (e.g., patient, resident, or the like bathrooms), cross corridor bathrooms (e.g., patient, resident, or the like cross corridor bathrooms). The anti-obstruction systems 100 of the present disclosure provide improved efficient solutions to access someone in the event a barrier 10 is obstructed and not able to open (e.g., not able to open inwardly). That is, in an emergency, the barrier 10 is able to swing in the opposite direction from the normal operation in order to minimize potential risks to people located on the opposite side of an obstructed barrier 10.

As will be discussed in further detail herein, the anti-obstruction system 100 utilizes one or more hinges 110 (e.g., a double swing hinge 112), a release stop 200 (otherwise described herein as an emergency release stop, or the like), and/or handle and lock hardware. The hinge 110 is operatively coupled to a frame 20 and/or a wall, and to an edge of a barrier 10 (e.g., a door), while the release stop 200 is operatively coupled to an opposing frame and/or an opposing wall. The release stop 200, as will be described in further detail herein, acts as the stop for the barrier 10 so that the barrier 10 can only swing in one direction (e.g., into a room). However, when the barrier 10 is required to swing in an opposite direction (e.g., outwardly from a room) the release stop 200 may be disengaged through the use of the release assembly 400 to allow the barrier 10 to swing in another direction (e.g., outwardly from a room). As will be described in further detail herein, the release assembly 400 may comprise a sliding release lock 410, a rod 430 operatively coupled to the sliding release lock 410, and a release connector 450. The release connector 450 is configured to restrict or allow movement of the sliding release lock 410 to allow for engagement or disengagement of the rod 430, and thus, the stop member 250 of the release stop 200.

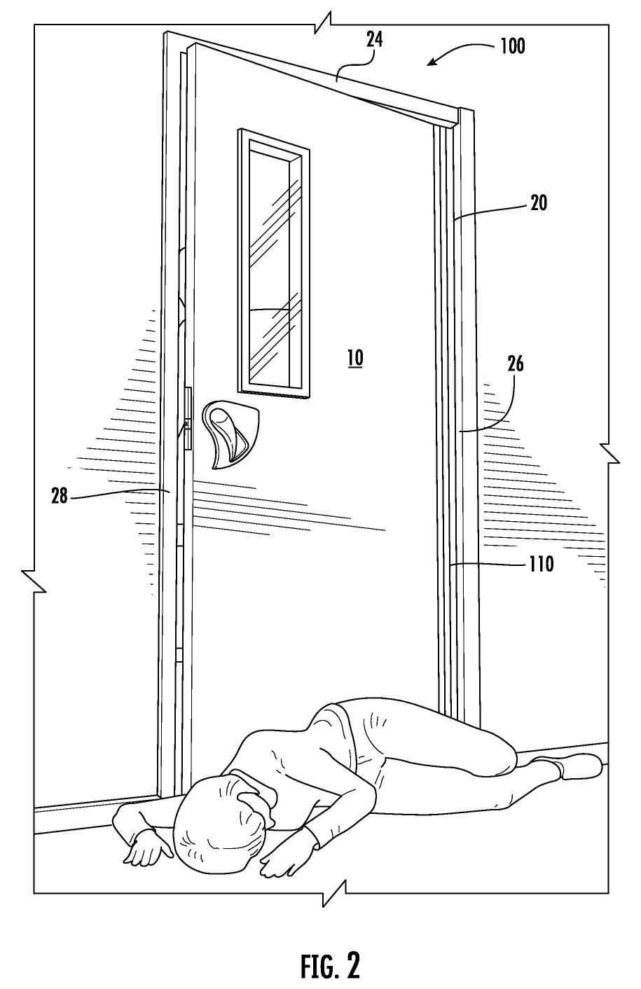

The anti-obstruction system 100, as installed, is illustrated in FIG. 1, while FIG. 2 illustrates an anti-obstruction system 100 with an obstructed barrier 10, in accordance with some embodiments of the present disclosure. As illustrated in FIG. 1, the hinge 110 of the anti-obstruction system 100 may be a continuous hinge (e.g., extending along a portion of, the majority of, or the entire length of the barrier edge of the barrier 10 and/or the barrier frame 20), and is operatively coupled to the barrier 10 and the barrier frame 20 for pivotal movement of the barrier 10 relative to the barrier frame 20 between a closed position and one or more open positions (e.g., including a fully open position). It should be understood that while the hinge 110 is illustrated and described as a double swing hinge 112 having knuckles and one or more pins, it should be understood that other types of hinges 110 (e.g., geared hinges, double action hinges, or other like hinges) may be used that allow a barrier 10 to swing in both directions when the release stop 200 is disengaged, as will be described herein.

As illustrated in FIGS. 1 and 2, the barrier 10 may be a door that is operatively coupled to a barrier frame 20, such as a door frame, which is operatively coupled to a wall (e.g., around an opening in a wall). The barrier frame 20 may comprise three (3) portions including an upper frame portion 24 disposed adjacent an upper end (e.g., header) of a barrier opening, and two side frame portions 26, 28 disposed along either edge of the barrier opening, with one side frame portion 26 being on the hinge side of the barrier 10, and the opposite side frame portion 28 being on the latch side of the barrier 10. The barrier frame portions 24, 26, 28 may be secured to each other and/or an adjoining structure by frame connectors (e.g., clips, tabs, fasteners, or the like).

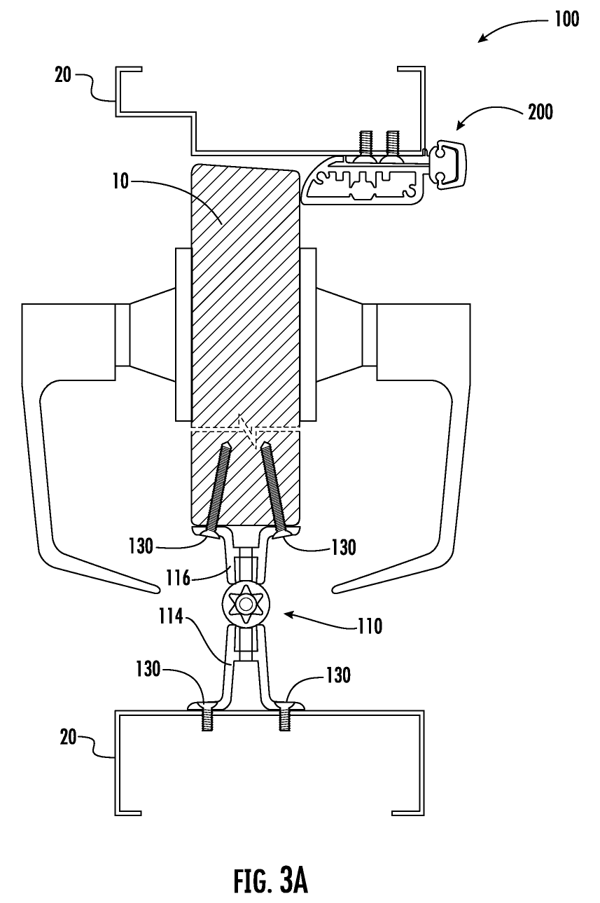

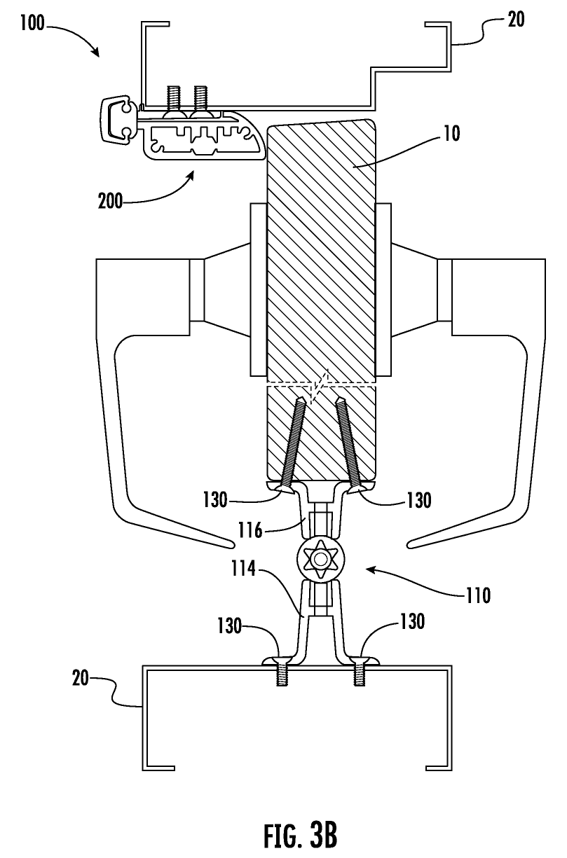

As illustrated in FIGS. 3A and 3B, the barrier 10 may be hung within the door opening by the hinge 110, such as through hinge connectors 130. The hinge connectors 130 may comprise fasteners that secure the hinge 110 through hinge apertures in a first hinge portion 114 to a barrier frame 20 (e.g., to one or more hinge reinforcements in the barrier frame 20) and/or to a wall. The hinge connectors 130 may secure a second hinge portion 116 of the hinge 110 to the barrier 10 (e.g., to a side edge that may or may not have hinge reinforcements in the door 10, to one or more faces of the barrier 10, or the like). Other types of hinge connectors 130, such as welds, non-removeable fasteners, or the like may be used to operatively couple the hinge 110 to the barrier 10 and/or barrier frame 20. It should be understood that the barrier 10 and barrier frame 20 may be any type of conventional door and door frame of any size and shape, and made of any type of material (e.g., wood, metal hollow, metal with a core, plastic, composite, or the like, or combinations thereof).

As further illustrated in FIGS. 3A and 3B, instead of using a traditional stop located in the barrier frame 20, the anti-obstruction system 100 of the present invention utilizes a release stop 200, which when engaged only allows the barrier 10 to swing in one direction (e.g., inwardly or outwardly). Alternatively, when the release stop 200 is disengaged the barrier 10 is able to swing in two directions (e.g., inwardly and outwardly).

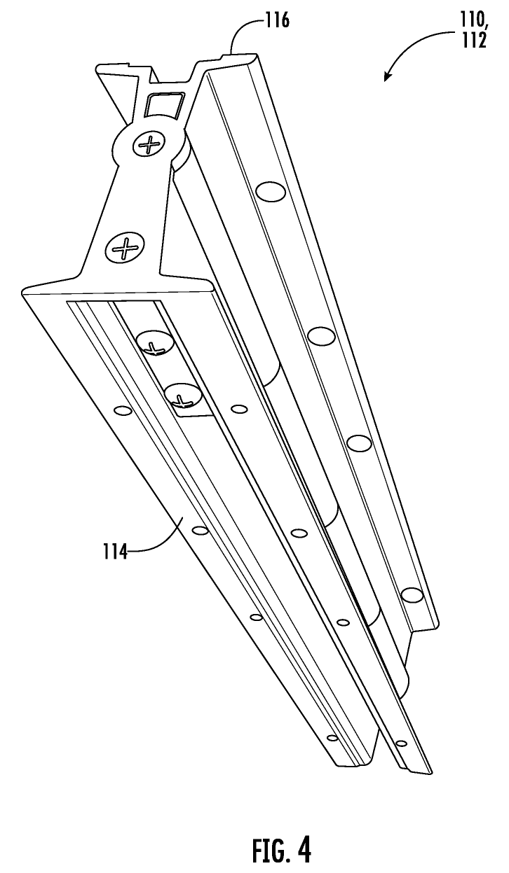

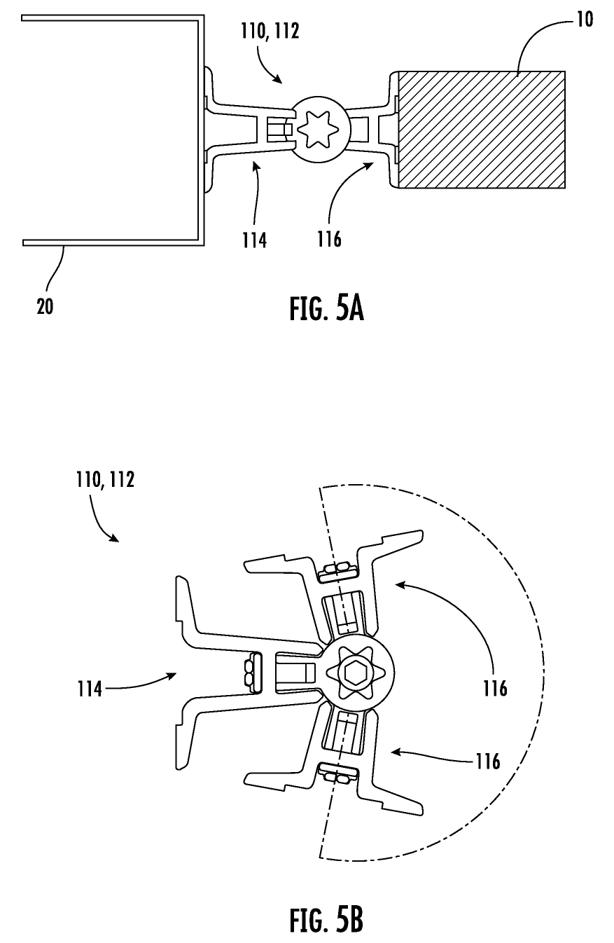

FIGS. 4 through 5B illustrate one embodiment of the hinge 110, in which the hinge 110 is a double swing hinge 112 having a first portion 114 that is configured for operative coupling with a barrier frame 20 or a wall, and a second portion 116 that is configured for operative coupling with a barrier 10. However, in other embodiments the hinge 110 may be geared hinges (e.g., interlocking teeth, or the like), double action hinges, or other types of double swing hinges. As illustrated in FIG. 5B, the second hinge portion 116 swings with respect to the first hinge portion 114 (e.g., at an angle of 100 degrees, or the like) to allow the barrier 10 to swing in either direction when not prevented by the release stop 200 or an obstruction to the barrier 10.

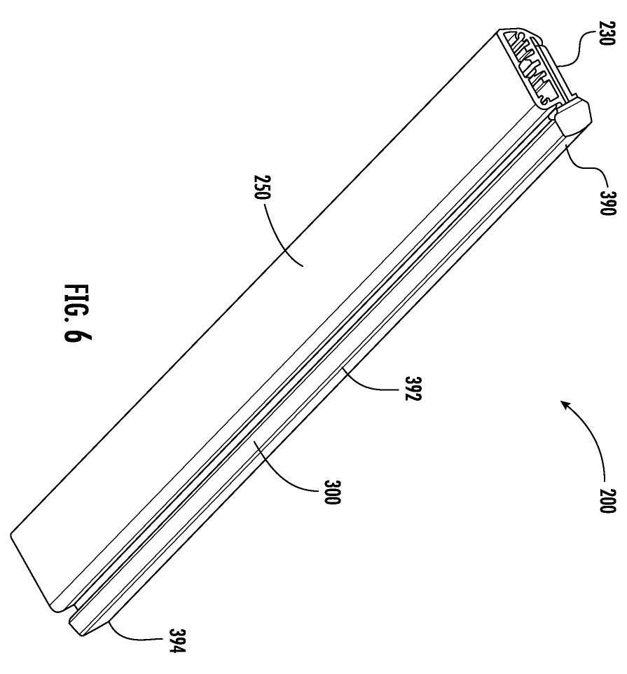

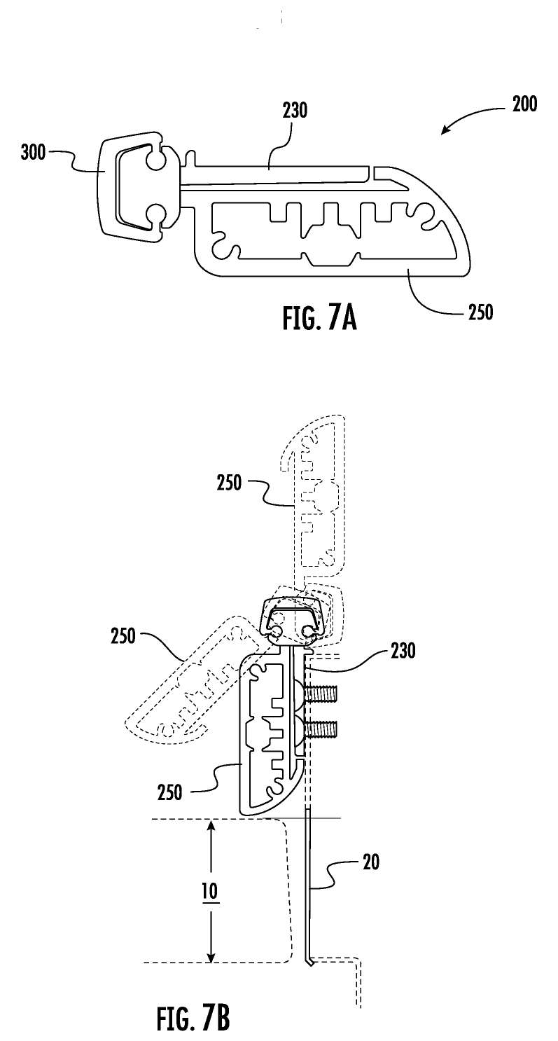

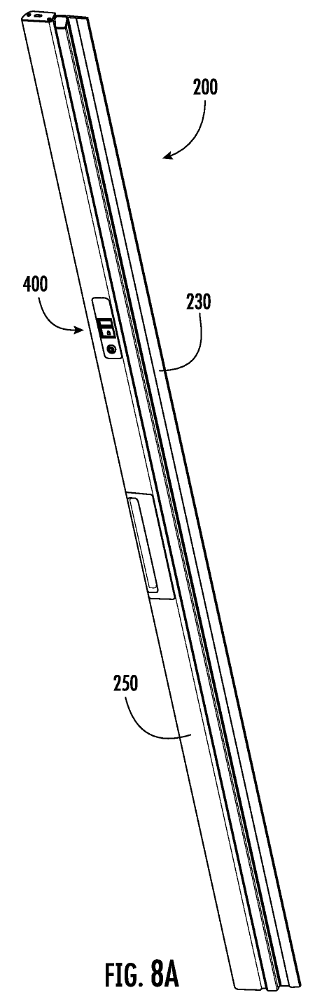

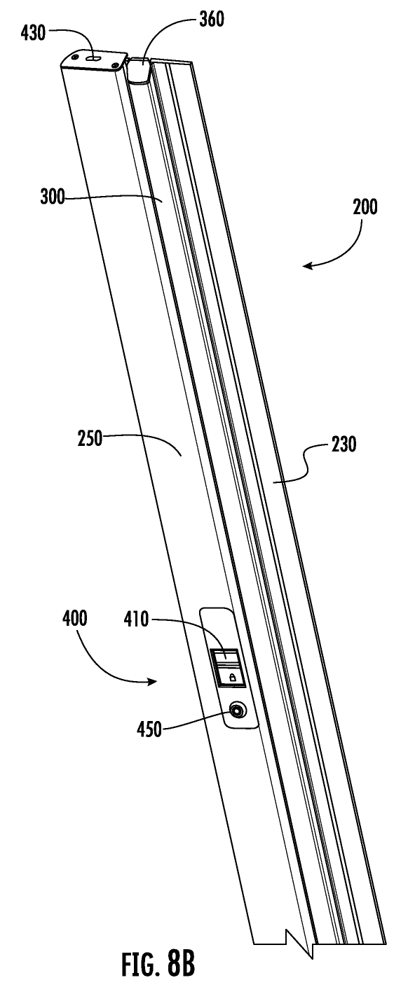

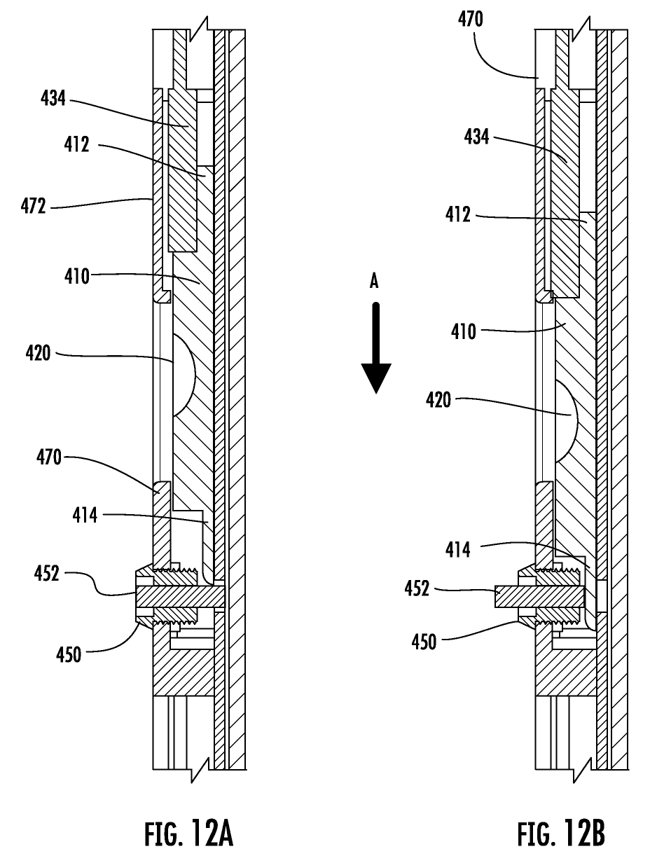

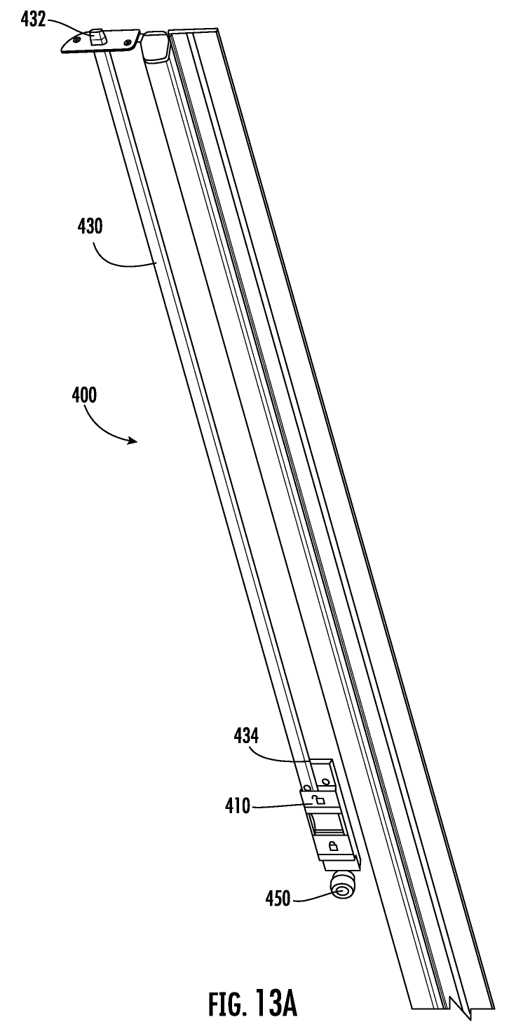

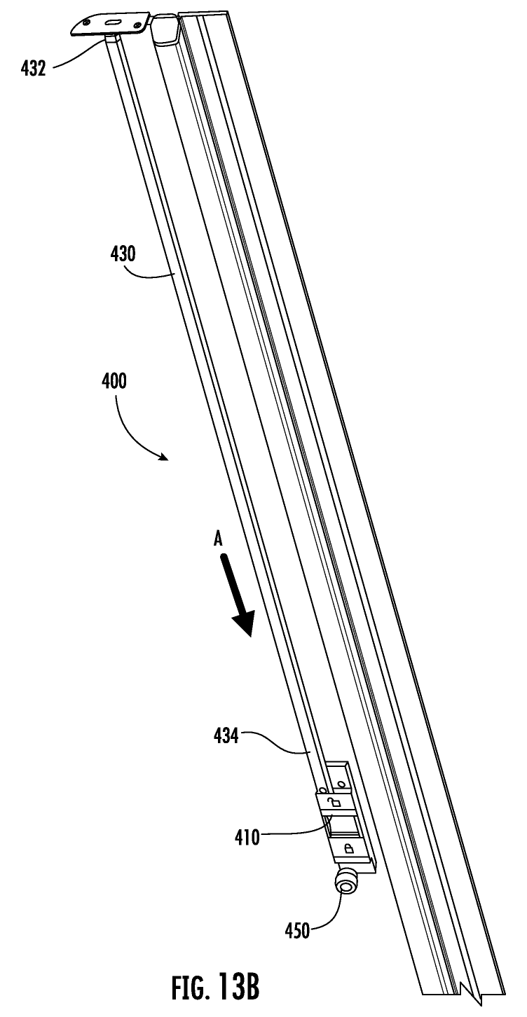

FIGS. 6 through 14 illustrates a release stop 200 (otherwise described as an emergency stop, an emergency release stop, or the like). As illustrated in FIGS. 6 through 7B, the release stop 200 comprises a first release portion 230 (otherwise described as a support member, a frame support member, or the like) and a second release portion 250 (otherwise described as a stop member, a release stop member, swing stop member, or the like), and a cover 300. As illustrated in FIGS. 8A through 13B, the release stop 200 further comprises a release assembly 400, as will be described in further detail herein. When in the locked position the release stop 200 acts as a frame stop that prevents a barrier 10 from swinging past the release stop 200. However, when there is a need for the barrier 10 to swing past the release stop 200, such as when an inwardly swinging door is obstructed, the release assembly 400 is utilized to move the release stop from an engaged position (as illustrated in FIGS. 12A and 13A) to a disengaged position (as illustrated in FIGS. 12B and 13B), in order allow the stop member 250 of the release stop 200 to move (e.g., rotate, as illustrated in FIG. 7B) such that the barrier 10 is able to swing in both directions (e.g., outwardly and inwardly). As illustrated in FIGS. 7A and 7B, the stop member 250, when disengaged, may be able swing 180 degrees (or more or less) with respect to the support member 230. As illustrated in FIGS. 3A, 3B, and FIGS. 7A through 7B, the support member 230 may be operatively coupled to a barrier frame 20 (or wall), while the stop member 250 acts as a frame stop when in the engaged position (e.g., locked position), and swings with respect to the support member 230 when in the disengaged position (e.g., unlocked position).

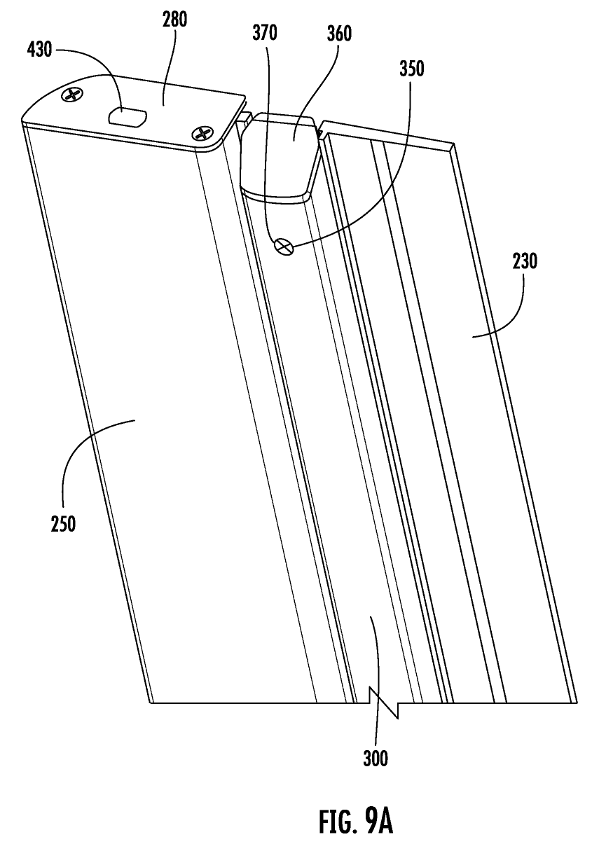

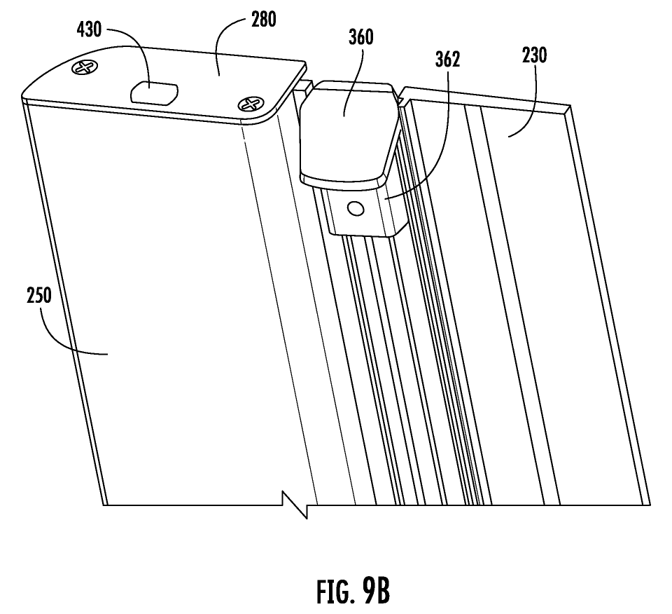

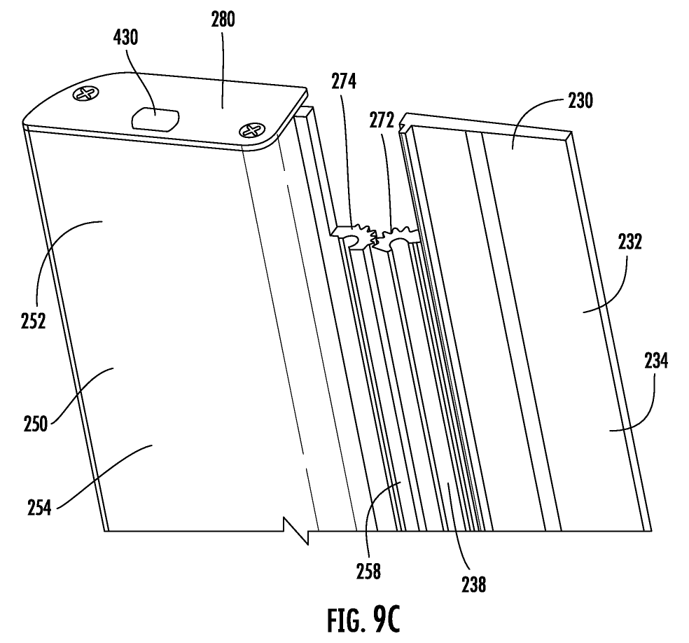

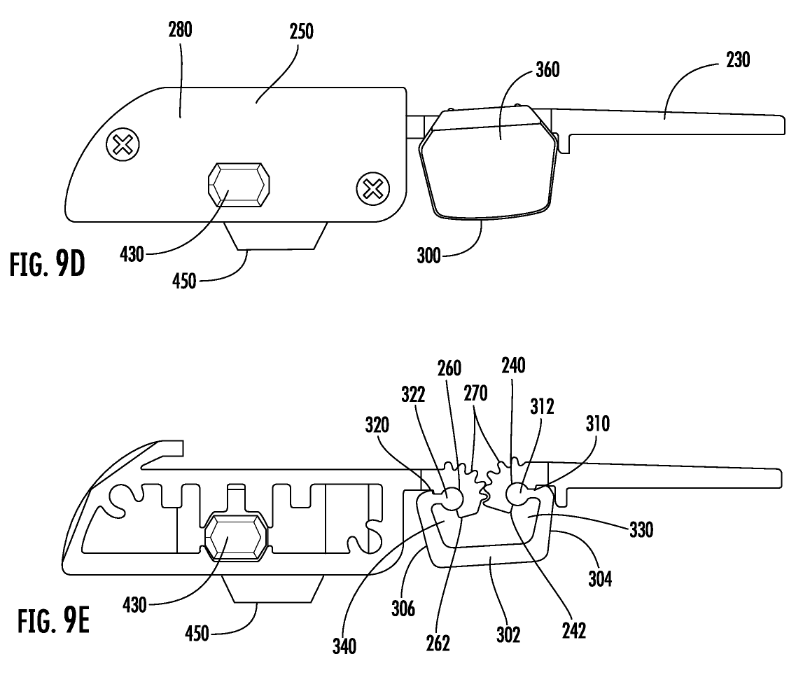

It should be understood that the stop member 250 may be able to rotate with respect to the support member 230 through any hinge connection. However, as illustrated in FIGS. 9A and 9E, the support member 230 and the stop member 250 may each have teeth 270 that interlock with each other to allow the stop member 250 to swing with respect to the support member 230 when the release assembly 400 is unlocked and disengaged. The support member 230 and the stop member 250 may each be described as having leaves, such as a first leaf 232 (otherwise described as a support leaf) and a second leaf 252 (otherwise described as a stop leaf). The first leaf 232 may be described has having a first web 234 (otherwise described as a support web) operatively coupled to a first head 238 (otherwise described as a support head). The second leaf 252 may be described as having a second web 254 (otherwise described as a stop web) operatively coupled to a second head 258 (otherwise described as a stop head). The first web 234 and the second web 254 may be integrally operatively coupled to (e.g., formed integrally with) the first head 238 and the second head 258, respectively. Alternatively, the first web 234 and the second web 254 may be formed separately from the first head 238 and the second head 258, and thereafter, operatively coupled to the first head 238 and the second head 258 (e.g., connected through fasteners, welds, or the like).

The first head 238 and the second head 258 may be continuous and extend along the entire length of the related webs 234, 254, or the heads 238, 258 may be discontinuous (e.g., have one or more slots between separate head portions) and be located only over a portion of the related webs 234, 254. For example, hinge slots (not illustrated) may be formed (e.g., milled, or the like) in the heads 238, 258 and one or more bearings (e.g., plastic, metal, composite, or other like bearings – not illustrated) may be operatively coupled to the heads 238, 258 at the locations of the hinge slots (e.g., the slots receive the bearings). The bearings keep adjacent leaves from sliding past each other. The heads 238, 258 may comprise gear teeth 270, extending therefrom (e.g., from substantially arcuate portion of each head 238, 258). The gear teeth 270 may be radial, helical, or other shaped gear teeth 270, and may extend around at least a portion of the heads 238, 258 (e.g., the arcuate portion for a distance adequate for the gear teeth to mesh throughout the range of motion of the release stop 200, or the like).

FIG. 9C further illustrates that a portion of the heads 238, 258 of the leaves 232, 252 may be notched with respect to the webs 234, 254. As such, the leaves 232, 252 of the release lock 200 may be longer than the heads 238, 258. The notched heads 238, 258 may allow for the cover cap body 362 to be extended into, and covered by, the cover 300 when installed.

FIGS. 9A and 9E illustrate a cover 300, which is operatively coupled to the support member 230 and the stop member 250, such as through the heads 238, 258 of the two leaves 232, 252, as will be described in further detail herein. The cover 300 may be generally C-shaped with a cover web 302, cover flanges (e.g., a first cover flange 304 and a second cover flange 306), and returns at each end 310, 320 (e.g., a first return 310 and a second return 320) of the cover flanges 304, 306. The end of the flanges 304, 306 and/or the returns 310, 320 may include pivot portions 312, 322 (e.g., a first pivot portion 312 and a second pivot portion 322) that act as pivot features (e.g., that are generally circular in cross-section, or having another shape). The pivot portions 312, 322 are received by the heads 238, 258 of the leaves 232, 252. As such, the heads 238, 258 may have hook portions 240, 260 (e.g., a first hook portion 240 and a second hook portion 260) that are used to receive the pivot portions 312, 322 of the of the cover 300. Each leaf 232, 252 pivots with respect to the pivot portion 312, 322 and/or the pivot portions 312, 322 pivot with respect to each leaf 232, 252, while the gear teeth 270 mesh centrally between the pivot portions 312, 322. The hook portions 240, 260 of the heads 238, 258 truncate abruptly at hook ends 242, 262, which in the illustrated embodiment are flat surfaces (however, the hook ends 242, 262 may have a surface of any shape). The hook ends 242, 262, in some embodiments, are truncated in order to permit the closing of the hinge release stop 200, when they are received within pockets 330, 340 in the cover 300, as shown in FIG. 9E. While the pivot portions 312, 322 are illustrated as generally circular in cross-section, the pivot portions 312, 322 can be any shape with which a portion of the leaves 232, 252 (e.g., the hook portions 240, 260, or other feature, may pivot).

The release stop 200 may be assembled by meshing the gear teeth 270, such as first head teeth 272 (e.g., support head teeth) with second head teeth 274 (e.g., stop head teeth) together in proper alignment, which may be most easily done in the position of FIG. 7A. This corresponds to the position when the release stop 200 is in an engaged position (e.g., locked) with the webs 234, 254 in or near contact with each other, and then the cover 300 may be slid over the heads 238, 258 of the leaves 232, 252. As illustrated in FIG. 9C, a portion of the returns 310, 320, and/or the pivot portions 312, 322 thereof, of the cover 300 may be notched with respect to cover flanges 304, 306 in order to allow for the cap body 362 of the cap cover 360 to fit within the cover 300.

As illustrated in FIG. 9A, in some embodiments the cover 300 may have a cover aperture 350 (e.g., a circular hole, a hole of a different shape, a slotted hole, or the like) that extends through at least a portion of the cover 300. In some embodiments, as illustrated in FIG. 9A, the cover aperture 350 may be located in the cover web 302. However, it should be understood that in some embodiments, the cover aperture 350 may be located in one of the cover flanges 304, 306. As will be discussed in further detail herein, the cover aperture 350 may receive a cover connector 370 that may be used to secure the cover cap 360 in place. It should be understood that the cover aperture 350 may be located in the web 302, in the first flange 304, in the second flange 306, or the like. The cover connector 370 may engage the cover cap 360 (e.g., such as a set screw), extend through the cover 300 and into the cover cap 360, or otherwise engage with the cover cap 360 to secure the cover cap 360 within the cover 300. Alternatively, the cover connector 370 may extend through the cover cap 360 (e.g., through the rear surface) and into the cover 300 (e.g., fully or partially). In other embodiments, the cover connector 370 may be a weld or other type of connector. Moreover, in some embodiments the cover connector 370 may extend through the cover 300 in a different location and engage with, extend into, or the like with the bearing (not illustrated) in order to hold the cover 300 in place. For example, the bearing may be similar to the body of the cover cap 360 (e.g., without the top of the cover cap 360).

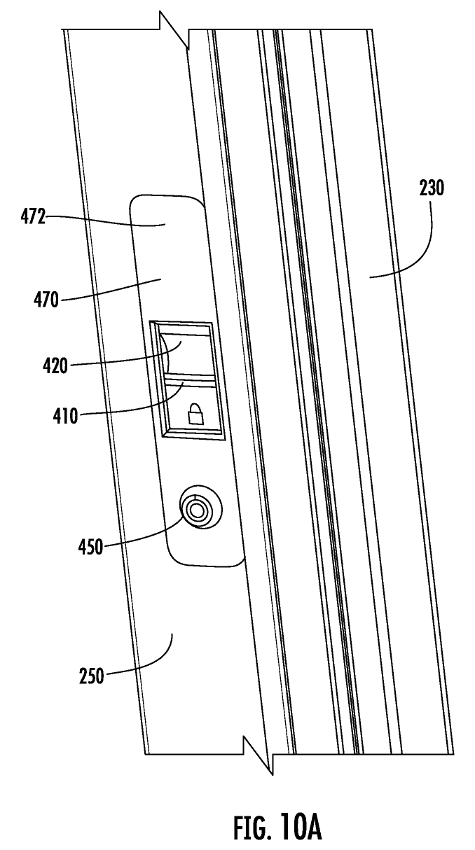

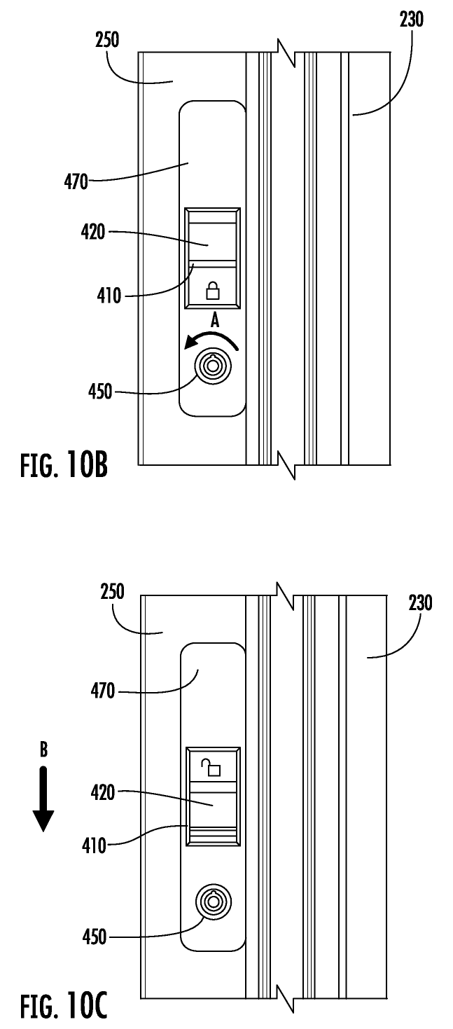

FIGS. 8A through 14 illustrate embodiments of the release stop 200 having the release assembly 400. As previously discussed, the release assembly 400 may comprise a sliding release lock 410, a rod 430 operatively coupled to the sliding release lock 410, and a release connector 450. The release connector 450 is configured to restrict or allow movement of the sliding release lock 410 to allow for engagement or disengagement of the rod 430, and thus the stop member 250 of the release stop 200. As illustrated in FIGS. 10A through 10C, the release connector 450, and thus the sliding release lock 410, may be unlocked and/or locked for allowing engagement or disengagement of the rod 430. In some embodiments, the release connector 450 may be any type of connector, such as a fastener (e.g., screw, bolt, nut), lever, button, keyed lock, clip, clamp, plug, flange, cam, button, and/or other connector. In some embodiments, the release connector 450 may comprise a push lock bolt and nut that may be locked and unlocked. As illustrated in FIGS. 10B and 10C, when the release connector 450 is moved from the locked to the unlocked position (e.g., rotated to the unlocked position as illustrated by arrow A), the release lock 410 may slide downwardly from the locked position to the unlocked position. In some embodiments, the release lock 410 may slide downwardly automatically, such as through the use of gravity due to the weight of the release lock 410 and/or rod 430. In other embodiments, the release lock 410 may slide through manual movement of the release lock 410 by a user, such as through the use of a finger aperture 420.

It should be understood that the release connector 450 may be locked or unlocked through the use of a tool (e.g., specialty tool, Allen wrench, key, screwdriver, square tool, hexagon tool, Torx tool, socket, pin head tool, or the like) that is able to rotate at least a portion of the release connector 450 clockwise or counterclockwise to unlock or lock the cover release connector 450, and thus, the release lock 410 (e.g., restrict the release lock 410 from sliding or allow the release lock 410 to slide). While the release connector 450 may be rotated through the use of a tool in order to lock or unlock the release lock 410, in other embodiments a tool may be used to release the connector 450 such that it may be moved (e.g., flipped, pulled, rotated, or the like) in order to unlock or lock the release lock 410. In some embodiments, the release connector 450 may comprise of a spring loaded quick disconnect, such that when the release connector 450 is disengaged (e.g., rotated, pushed, or the like) the spring loaded release connector 450 may disengage the release connector 450 from the release lock 410. It should be understood that the release connector 450 may be any type of connector that may be used to allow or restrict the locking and/or unlocking of the release lock 410.

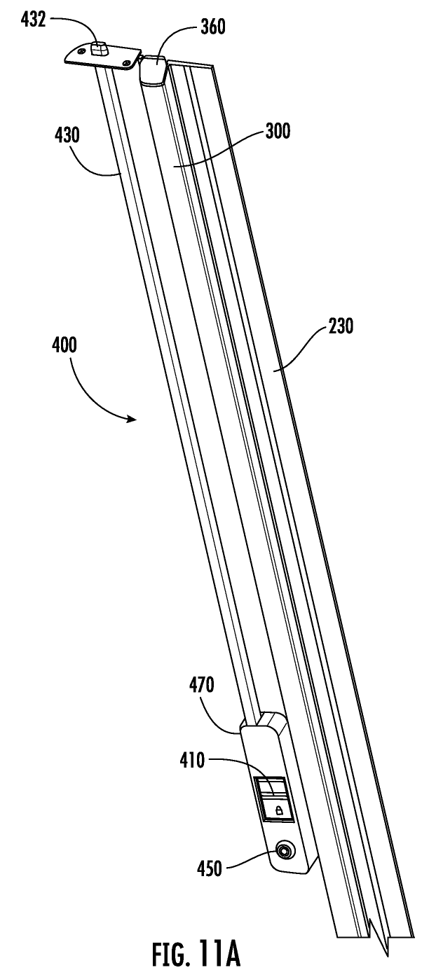

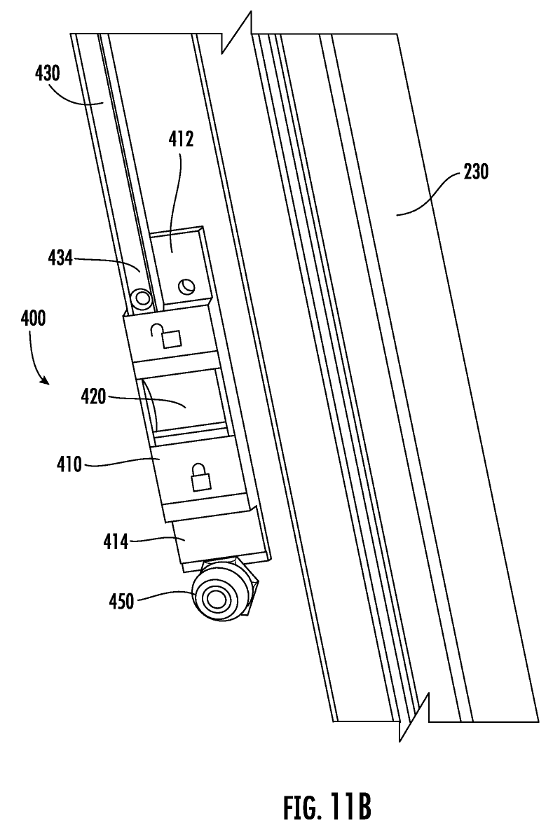

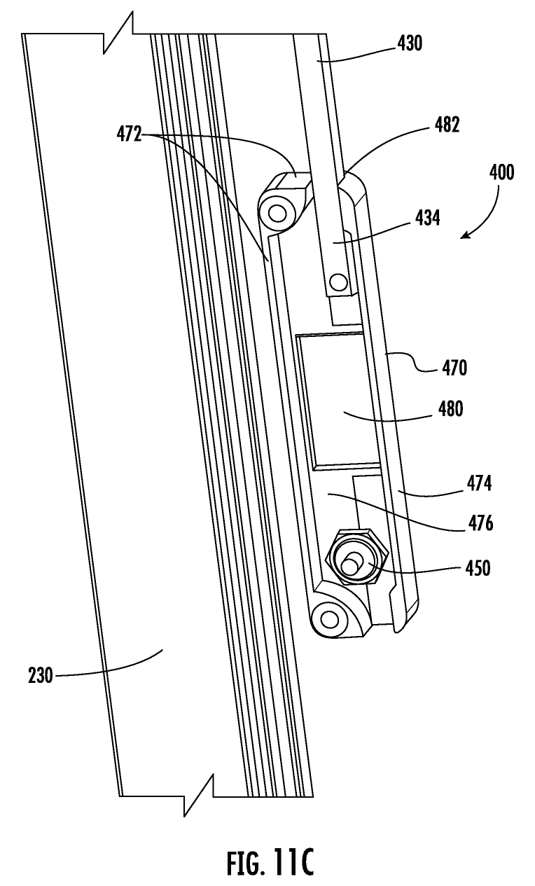

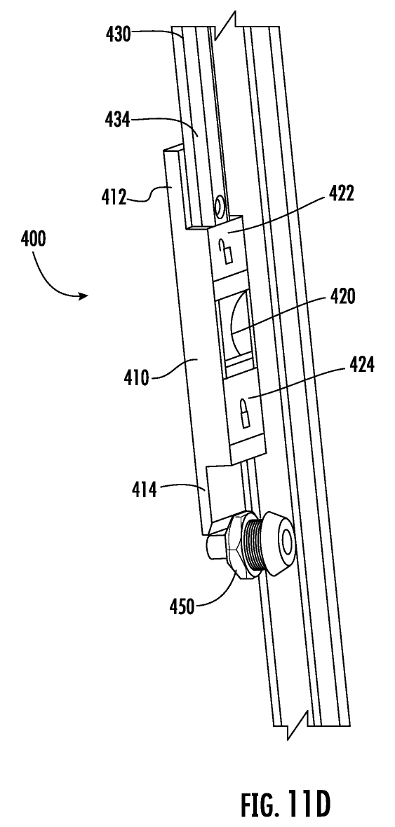

Embodiments of the release assembly 400 will be described in further detail with respect to FIGS. 11A through 13B. FIG. 11A illustrates a portion of the release stop 200 with the release member 250 removed, and FIG. 11B illustrates an enlarged view of the release assembly 400 with the release housing 470 removed. As illustrated in the figures, the rod 430 comprises a first rod end 432 (otherwise described as a distal end 432) and a second rod end 434 (otherwise described as a proximal end 434). The rod 430 may be any type of rod, such as solid, hollow, partially hollow, or the like rod of any shape and/or size. For example, the rod 430 may have a cross-sectional shape that is circular, oval, square, rectangular, triangular, any polygon, uniform, non-uniform, or the like shape along the length of the rod 430, or the rod 430 may have different cross-sectional shapes at different locations along the length of the rod 430. A portion of the rod 430 at the distal end 432 may extend out of the release member 250 (e.g., out of a release member cap 280 that is operatively coupled to the release member 250). Moreover, the rod 430 may be operatively coupled to the release lock 410 at the proximal rod end 434. For example, as illustrated in FIGS. 11B and 11D, the release lock 410 may comprise a first projection 412 (otherwise described as a rod projection 412) that is operatively coupled to the rod 430. For example, the first projection 412 may form an upper shoulder in which the proximal end 434 of the rod 430 may sit. The proximal end 434 may be operatively coupled to the release lock 410 using a rod connector (e.g., a clip, clamp, fastener, such as a screw, bolt, nut, or the like, a pin, such as a dowel pin, or the like). It should be understood that the rod 430 may be operatively coupled to the release lock 410 in other ways (e.g., screwed into each other, inserted into an aperture, or the like).

As further illustrated in FIGS. 11B and 11D, the release lock 410 may comprise a second projection 414 (otherwise described as release connector projection 414) to which the release connector 450 may be operatively coupled to allow for unlocking and locking of the release lock 410. For example, as illustrated in FIGS. 12A and 12B, when the release connector 450 is unlocked the release connector 450 is disengaged from the release lock 410 (e.g., from the second projection 414, or the like) and in response, the release lock 410 may slide downwardly. In some embodiments, the release connector 450 may comprise a connector projection 452 (e.g., a plug, plunger, rod, or the like of any shape and size) that is configured to extend to engage with the second projection 414 of the release lock 410 (e.g., with an end of the second projection 414 or another component, such as the release housing 470, release member 250, or the like, or an aperture therein, or the like) when the release lock 410 is locked. Alternatively, the connector projection 452 is configured to retract to disengage with the second projection 414 of the release lock 410 (e.g., with an end of the second projection 414 or another component, such as the release housing 470, release member 250, or the like, or an aperture therein) when the release lock 410 is unlocked. In particular embodiments, as illustrated in FIG. 12A, the second projection 414 of the release lock 410 rests on top of the connector projection 452 (e.g., plunger) when the release lock 410 is in the lock position. As illustrated in FIG. 12B, when the release connector 450 is disengaged, the connector projection 452 (e.g., plunger) retracts, and the release lock 410 slides downwardly (e.g., the second projection 414 slides downwardly past the connector projection 452) such that the release lock 410 is moved into the unlocked position.

As further illustrated in 12B and 13B, when the release lock 410 slides downwardly, the rod 430 also slides downwardly, such that the proximal end 434 of the rod 430 is retracted, and thus, the distal end 432 is retracted (e.g., within the release member 250 and/or the release member cap 280). As such, the rod 430 is disengaged from a rod stop (not illustrated), which allows the release member 250 to swing open with respect to the support member 230. It should be understood that in some embodiments the rod stop may be a frame aperture formed within the frame and/or a wall aperture formed within the wall (e.g., of any shape or size). As such, the rod stop may be formed by the frame 20 and/or the wall. In other embodiments, the rod stop may be a component that is operatively coupled to the frame 20 (e.g., within and/or outside of the frame) and/or the wall (e.g., within and/or outside of the wall). The rod stop may be a housing with a rod stop aperture therein that restricts the movement of the rod 430 when the rod is engaged with the rod stop (e.g., inserted into an aperture in the rod stop, or the like).

As further illustrated in FIGS. 11A through 11C, the release housing 470 may include a front face 472 and one or more sides 474, which form a release lock cavity 476 in which the release lock 410 may be at least partially located (e.g., the release housing 470 may at least partially surround the release lock 410). Moreover, the front face 472 of the release housing 470 may comprise a finger aperture 480 through which a user may aid in unlocking the release lock 410 (e.g., sliding the release lock 410). Furthermore, the one or more sides 474 of release housing 470 may comprise a rod aperture 482, through which the rod 430 (e.g., second end 434) may slide when the release lock 410 is disengaged or engaged.

The release lock 410 may be located anywhere along the length of the stop member 250. As illustrated in FIG. 8A, the release lock 410 may be located generally around the mid-point of the upper half of the stop member 250, around the mid-point of the stop member 250, and/or any other portion of the stop member 250. However, it should be understood that the release lock 410 may be located anywhere along the length of the stop member 250 of the release stop 200, such as adjacent the upper end (as installed) of the stop member 250, adjacent the lower end of the stop member 250, or anywhere in-between the upper end and the lower end of the stop member 250. Moreover, while the rod 430 is illustrated as being located within the upper portion of the stop member 250, it should be understood that, additionally or alternatively, the rod 430 may be located within the lower portion of the stop member 250. As such, in some embodiments the rod 430 may be extended and/or retracted through the lower end of the stop member 250 for engagement or disengagement with the rod stop that is located in the floor and/or a housing coupled to the floor.

While the sliding release lock 410 is illustrated and described as sliding vertically (e.g., generally upwards and downwards with respect to the floor), it should be understood that the release lock 410, the rod 430, and/or the release connector 450 may be configured in different ways in order to engage and/or disengage the rod 430. For example, in some embodiments, when the release connector 450 is unlocked, the rod 430 is retracted by the movement of the release connector 450. For example, the release connector 450 may be rotated (e.g., counterclockwise, or the like), and as such, the rotation of the release connector 450 may move the release lock 410 such that the rod 430 is disengaged. Additionally, or alternatively, the release lock 410 may slide horizontally, at an angle, and/or in two or more different directions in order to engage and/or disengage the rod 430. As such, it should be understood that the release assembly 400 may be configured in various ways in order to allow for the disengagement and/or engagement of the rod 430, and in particular embodiments, to allow for automatic disengagement of the rod 430. It should be further understood that in some embodiments, in addition to the use of gravity, or instead of utilizing gravity, a biasing member may be utilized to automatically unlock the release lock 410 when the release connector 450 is unlocked. For example, the release lock 410 may be biased (e.g., through the use of spring or other biasing member) such that when the release connector 450 is unlocked, the release lock 410 may biased into an unlocked position that allows and/or aids in disengaging the rod 430.

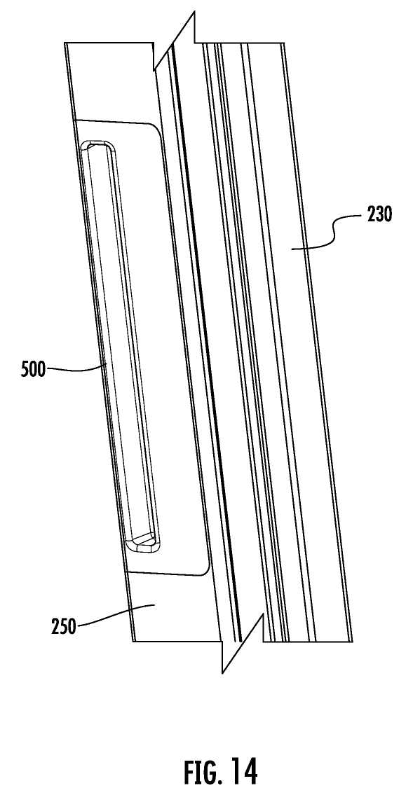

As illustrated in FIG. 14, in some embodiments, the stop member 250 may further comprise a grip 500 that allows a user to aid in swinging the stop member 250, if necessary, after the release assembly 400 is disengaged and/or to reposition the stop member 250 during engagement. In some embodiments the grip 500 may be an outwardly projecting grip that extends outwardly from the stop member 250. However, in other embodiments, the grip 500 may comprise an inwardly projecting grip 502 that extends at least partially into the stop member 250, as illustrated in FIGS. 8A and 14. In some embodiment, the grip 500 may both have a portion that extends outwardly (not illustrated) and a portion that extends inwardly. In some embodiments the grip 500 may have a grip aperture extending therethrough (e.g., that forms a handle), which allows a user to extend one or more fingers (e.g., a single finger, multiple fingers, a hand, or the like) through the grip 500. In other embodiments, the grip 500 provides an indention that allows a user to utilize one or more fingers to grasp the grip 500 to move the stop member 250 for disengagement or engagement.

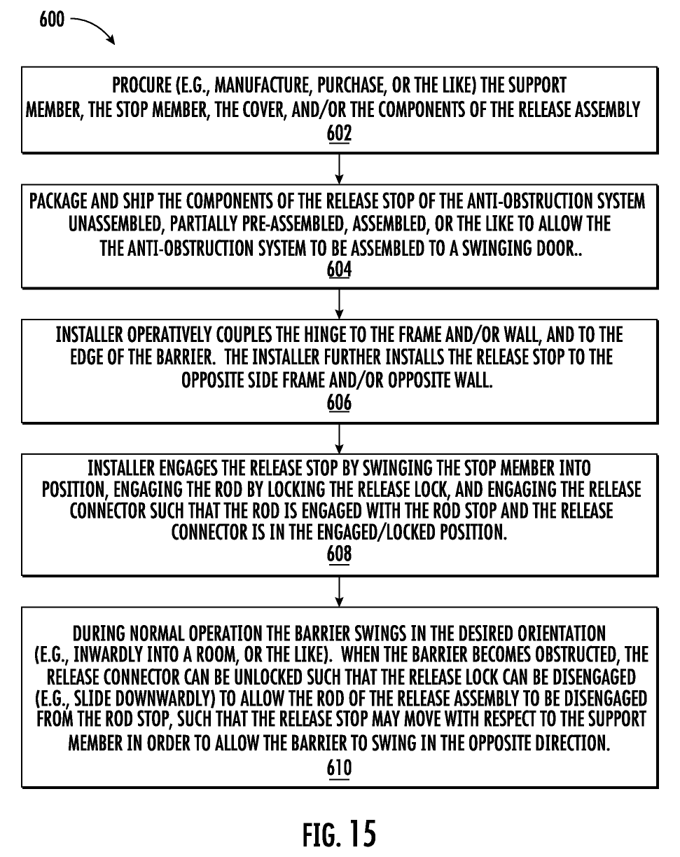

FIG. 15 illustrates a process 600 of manufacturing, installing, and operating the anti-obstruction door system 100. As illustrated in block 602 of FIG. 15, the release stop 200 members 230, 250, such as the leaves 232, 252 and/or the cover 300 are procured (e.g., manufactured, purchased, or the like). Furthermore, the release assembly 400, such as the components thereof, may be procured (e.g., manufactured, purchased, or the like). For example, portions of the release stop 200 may be cast, extruded, molded, machined, or the like, or combinations thereof. The materials used for the release stop 200 may include, for example, various materials such as aluminum, steel, stainless steel, plastic resin, composite (e.g., plastic resin over-molded onto a substrate of different material, or other like composites), or the like, or combinations thereof.

Block 604 of FIG. 15 further illustrates that the components of the release stop 200 may be at least partially assembled. For example, the release assembly 400 may be operatively coupled with the stop member 250, as previously described herein. Moreover, the support member 230 (e.g., first leaf 232) may be operatively coupled to the stop member 250 (e.g., second leaf 252) through the use of the cover 300. For example, the heads 238, 258 are interlocked together (e.g., interlocking the teeth 270) and the cover 300 is slid over at least a portion of the heads 238, 258. As such, the components of the anti-obstruction system 100, including the release assembly 200, may be shipped unassembled, at least partially pre-assembled, or assembled. While the release stop 200 may be sent assembled, alternatively, in some embodiments the release stop 200 may be sent at least partially unassembled to be assembled on site. Moreover, the hinge 110, a barrier handle and door lock (not specifically discussed herein), the door frame 20, and/or the door 10, may be sent unassembled, partially assembled, or the like.

Block 606 of FIG. 15 further illustrates that an installer may assemble the frame 20 to the wall and/or operatively couple the hinge 110 to the frame 20 or a wall, and to the edge of the barrier 10 (e.g., door edge, or the like) using connectors 130. The installer further operatively couples the support member 230 (e.g., first leaf 232) of the release stop 200 to the opposite side frame 20 or the wall on the opposite side of the opening in the wall. If the release stop 200 is not pre-assembled, the installer further operatively couples the stop member 250 (e.g., second leaf 252) to the support member 230 (e.g., first leaf 232) through the use of the cover 300. For example, the heads 238, 258 are interlocked together (e.g., interlocking the teeth 270) and the cover 300 is slid over at least a portion of the heads 238, 258.

FIG. 15 further illustrates in block 608 that the release stop 200 is engaged. For example, the installer engages the release stop 200 by sliding the rod 430 into the engaged position and allowing the release lock 410 to be locked. For example, the release connector 450 may require the installer to engage the release connector 450 (e.g., by rotating the release connector 450, or the like). Alternatively, the release connector 450 may automatically spring into the engaged position when the release lock 410 is slid into the locked position. As previously discussed herein, when the release stop 200 is engaged, the rod 430 is engaged with the rod stop that restricts the movement of the stop member 250. The installer may further install the handle and/or other barrier components.

FIG. 15 further illustrates in block 610 that the barrier 10 swings in the desired orientation (e.g., inwardly into a room) during normal operation and is prevented from swinging in the opposite direction by the engaged release stop 200. Should the barrier 10 become obstructed (e.g., as illustrated in FIG. 2), the release connector 250 is disengaged/unlocked such that the release lock 410 may be disengaged/unlocked (e.g., slid downwardly, moved another direction, or the like). As such, the stop member 250 of the release stop 200 is able to move (e.g., swing, slide, or the like) with respect to the support member 230 to allow the barrier 10 to swing in the opposite direction past the stop member 250.

The anti-obstruction system 100 of the present disclosure having the release stop 200 with the release assembly 400 provides an improved system for installing, accessing, and engaging/disengaging a release stop 200. Traditional anti-obstruction systems require a user to take an action after unlocking the system in order to allow the release stop 200 to become disengaged. Unlike traditional anti-obstruction systems, the system of the present disclose may be configured with a release assembly 400 that automatically disengages when the release assembly 400 is unlocked. For example, the rod 430 may automatically drop due to gravity when the release connector 450 is unlocked. However, should the release rod 430 and/or the sliding release lock 410 become stuck, a user may still manually slide the release lock 410 in order to move the release bar 430 to allow disengagement of the release assembly 400, and thus, the disengagement of the stop member 250 of the release stop 200. Furthermore, traditional anti-barricade systems may be more difficult to assemble, access, and/or open (e.g., based on location, configuration, or the like). The release assembly 400 of the release stop 200 of the present disclosure allows for ease of assembly, access, and/or engagement and disengagement of the release lock 410 in order to quickly gain access to an area which may be obstructed. As such, the release assembly 400 of the present disclosure may provide improved access to an obstructed room, which in turn may provide improved access to a room with an emergency situation (e.g., a person under duress, a person having a medical emergency, or the like)

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and should not be interpreted in an idealized or overly formal sense unless expressly so defined herein. Certain terminology is used herein for convenience only and is not to be taken as a limitation on the invention. For example, words such as “top,” “bottom,” “side,” “distal,” “proximal,” “upper,” “lower,” “left,” “right,” “horizontal,” “vertical,” “upward,” “downward”, “first”, “second”, or other like terminology merely describe the configuration shown in the figures. The referenced components may be oriented in an orientation other than that shown in the drawings and the terminology, therefore, should be understood as encompassing such variations unless specified otherwise.

It will be understood that when an element is referred to as “operatively coupled,” “coupled,” “connected,” or another similar term to another element, the elements can be formed integrally with each other, or may be formed separately and put together. Furthermore, “operatively coupled,” “coupled,” “connected,” or another like terms can mean the element is directly operatively coupled, coupled, connected, or the like to the other element, or intervening elements may be present between the elements. Furthermore, “operatively coupled,” “coupled,” “connected,” or other like term may mean that the elements are detachable from each other, or that they are permanently operatively coupled, coupled, connected, or other like term together.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A release stop for a barrier, the release stop comprising:
a support member configured to be operatively coupled with a frame or a wall;
a stop member operatively coupled with the support member;
a cover operatively coupled to the support member and the stop member; and
a release assembly operatively coupled to the stop member, wherein the release assembly comprises:
a sliding release lock;
a rod operatively coupled to the sliding release lock; and
a release connector;
wherein the release connector is configured to restrict or allow movement of the sliding release lock to allow for engagement or disengagement of the rod; and
wherein in an engaged position the rod is engaged to restrict movement of the stop member; and
wherein in a disengaged position the rod is disengaged to allow movement of the stop member.

2. The release stop of claim 1, wherein the release assembly further comprises:
a release housing at least partially covering the sliding release lock;
wherein the release housing forms a finger aperture configured to allow a user to slide the sliding release lock.

3. The release stop of claim 1, wherein the rod comprises a proximate end operatively coupled to the sliding release lock and a distal end that is configured to engage and disengage with a rod stop.

4. The release stop of claim 3, wherein in the disengaged position the rod is located within the release stop, and wherein in the engaged position the distal end extends from the release stop.

5. The release stop of claim 3, wherein the sliding release lock comprises:
a rod projection, wherein the rod is operatively coupled to the rod projection.

6. The release stop of claim 3, wherein the rod stop is formed by the frame having a frame aperture, the wall having a wall aperture, or rod stop housing operatively coupled to the frame or the wall.

7. The release stop of claim 1, wherein the sliding release lock comprises:
a connector projection;
wherein the release connector is configured to restrict and allow movement of the sliding release lock through locking and unlocking with the connector projection.

8. The release stop of claim 1, wherein when the sliding release lock and the release connector are in a locked position the rod is in the engaged position.

9. The release stop of claim 1, wherein when the release connector and the sliding release lock are in an unlocked position the rod is in the disengaged position.

10. The release stop of claim 9, wherein when the release connector is unlocked the sliding release lock slides downward to the unlocked position automatically to move the rod to the disengaged position.

11. The release stop of claim 1, wherein the stop member comprises:
a stop web; and
a stop head with stop teeth, wherein the stop head extends from the stop web.

12. The release stop of claim 11, wherein the support member comprises:
a support web; and
a support head with support teeth, wherein the support head extends from the support web.

13. The release stop of claim 12, wherein the cover extends over at least a portion of the support head and the stop head.

14. The release stop of claim 13, wherein the cover comprises:
a cover web;
one or more cover flanges; and
one or more returns extending from the one or more cover flanges;
wherein the stop head or the support head receives the one or more returns.

15. The release stop of claim 1, further comprising:
a cover cap operatively coupled with the cover; and
a stop member cap operatively coupled with the stop member.

16. An anti-obstruction system, the system comprising:
a door frame operatively coupled to a wall;
a door having a first door edge and a second door edge;
one or more hinges operatively coupled to a first frame portion of the door frame and the door adjacent the first door edge;
a release stop comprising:
a support member operatively coupled to a second frame portion of the door frame;
a stop member configured to engage and disengage with the door adjacent the second door edge;
a cover operatively coupled to the support member and the stop member; and
a release assembly operatively coupled to the stop member, wherein the release assembly comprises:
a sliding release lock;
a rod operatively coupled to the sliding release lock; and
a release connector;
wherein the release connector is configured to restrict or allow movement of the sliding release lock to allow for engagement or disengagement of the rod; and
wherein in an engaged position the rod is engaged to restrict movement of the stop member; and
wherein in a disengaged position the rod is disengaged to allow movement of the stop member.

17. The anti-obstruction system of claim 16, wherein when the sliding release lock and the release connector are in a locked position the rod is in the engaged position.

18. The anti-obstruction system of claim 16, wherein when the release connector and the sliding release lock are in an unlocked position the rod is in the disengaged position.

19. The anti-obstruction system of claim 18, wherein when the release connector is unlocked the sliding release lock slides downward to the unlocked position automatically to move the rod to the disengaged position.

20. A method of using an anti-obstruction system for allowing a barrier that swings inwardly to swing outwardly, the anti-obstruction system comprising a door frame operatively coupled to a wall, a door having a first door edge and a second door edge, one or more hinges operatively coupling a first frame portion of the door frame and the door adjacent the first door edge, and a release stop comprising a support member operatively coupled to a second frame portion of the door frame, a stop member configured to engage and disengage with the door adjacent the second door edge, a cover operatively coupled to the support member and the stop member, and a release assembly operatively coupled to the stop member, wherein the release assembly comprises a sliding release lock, a rod operatively coupled to the sliding release lock, and a release connector, the method comprising:
unlocking the release connector to allow movement of the sliding release lock;
moving the sliding release lock to move the rod from an engaged position to a disengaged position to allow for movement of the stop member; and
moving the stop member to allow the door to swing outwardly past the stop member.
